(19) United States
(12) Patent Application Publication
(10) Pub. No.: US 2014/0100094 A1
(43) Pub. Date: Apr. 10, 2014

(54) TOOL MAGAZINE AND MACHINING CENTER

(71) Applicant: Komatsu NTC Ltd., Nanto (JP)

(72) Inventors: Junichi HAYASHI, Nanto (JP); Fumihiro KAMIKONYA, Nanto (JP); Yasuo HASEGAWA, Nanto (JP)

(73) Assignee: Komatsu NTC Ltd., Nanto (JP)

(21) Appl. No.: 14/105,115

(22) Filed: Dec. 12, 2013

Related U.S. Application Data
(63) Continuation of application No. 13/509,284, filed on May 11, 2012.

(30) Foreign Application Priority Data
Nov. 18, 2009 (JP) 2009-262984

(51) Int. Cl. B23Q 3/155; B23Q 3/157

(52) U.S. Cl. CPC B23Q 3/15526; B23Q 3/157
USPC 483/30; 483/66; 483/67; 483/68

(57) ABSTRACT

A tool magazine that can make a long tool reasonably coexist with other tools and a machining center with the tool magazine are provided. The tool magazine has a rotatable magazine main body and plural of tool holders installed on the magazine main body. Each of the tool holders moves to a tool exchange position sequentially. A part or all of the tool holders has a capability of changing between an exchange posture that holds the tool in parallel to a rotation shaft of the magazine main body and a transport posture that holds the tool along with a plane perpendicular to the rotation shaft of the magazine main body. The tool holder capable of changing postures takes the exchange posture when it locates in the tool exchange position and takes the transport posture when it leave the exchange position. The machining center has the above tool magazine.

### FIELD OF INVENTION

The present invention relates to a tool magazine for retaining tools to be attached to a main shaft and a machining center with the tool magazine.

### BACKGROUND OF THE INVENTION

A machining center has an automatic tool changer (ATC) that changes a tool attached to a main shaft wish tools kept in a tool magazine automatically, and applies various kinds of processes to a work sequentially. Such tool magazine is known either in a form of disk shape (patent document 1) or chain shape (patent document 2), at the time of the tool exchange, it transfer a tool by moving either one of the tool magazine and the main shaft or both of them (patent document 1) or through an ATC arm. In these tool magazines, all tools are held in the direction parallel to an rotational axis direction of the tool magazine. Also, these tool magazines are covered with a magazine cover in general.

### PRIOR ART

### Patent Literature

Patent Literature 1: Japanese patent application laid-open H7-214445

Patent Literature 2: Japanese patent application laid-open 2008-149416

### SUMMARY OF THE INVENTION

### Problem Solved by the Invention

However, as shows is FIG. 8(a) god FIG. 8(b) (a case the tool magazine having a main body 101 of disk shape and tool holders 102 located is its penumbra as an example), where there is a tool longer than the other tools T (a long tool TL) among plural tools T, the size of a magazine cover 103 needs to be larger (FIG. 8(a)) in order to avoid interference between the long tool TL and the magazine covet 103 (as illustrated in broken chain lines), or the long tool TL needs to be stored at separate location. In the case that the magazine cover 103 is enlarged, the whole machining center size become larger. And in the case that the long tool TL is stored at another location, an external tool holder 112 is necessary to be added and a main shaft S needs to be controlled so as to move to an external tool exchange position P2 that is different from an ordinary tool exchange position P1, which create a problem for the long tool to coexist with other tools. Additionally, even in the case that there is no magazine cover, it is necessary to save enough clearance so that a long tool does not interfere with other structures, which causes the whole machining center larger as a result. Even more, in the case of the tool magazine of the disk shape, there are problems that inertia of the tool magazine as a whole become larger as a heavy long tool is held around a disk and resultant misalignment of a center of gravity from a center of rotation creates extra load to a motor and a rotating shaft that rotates the magazine main body. Furthermore, in the case of the tool magazine of chain shape, there is a problem the piece holding a long tool will receive a large moment when tools are held in a horizontal direction, which causes extra load to the chain and motor rotating it.

In consideration of the foregoing, it is an object of the present invention to provide a tool magazine that can make a long tool reasonably coexist with other tools and a machining center with such tool magazine.

### Problem Solution Means

Among others, the tool magazine according to the first invention is for holding tools on a main shaft of a machining center having a rotatable magazine main body, multiple of tool holders installed on the magazine main body, each of the tool holders moves to a tool exchange position sequentially, a portion or all of the tool holders can change its posture between an exchange posture where a tool is hold in a direction that is parallel to an axial direction of the magazine main body and a transport posture where a tool is held in a direction that is perpendicular to the axial direction of the magazine main body, and the tool holder capable of changing its posture takes the exchange posture when the tool holder is located at the tool exchange position and takes the transport posture when the tool holder leaves from the tool exchange position.

Among others, the tool magazine according to the second invention is that the shape of the magazine main body is disk like shape and rotating about the disk center axis, the tool holder is located at the penumbra of the magazine main body, a portion including the penumbra of the magazine main body is formed as a separate body part, and the separate body part can stand up relative to the disk surface, the tool holder can take an exchange posture by aligning along with the disk surface and hold a transport posture by standing up relative to the disk surface.

Among others, the tool magazine according to the third invention is that the magazine main body is annular chain shape and driven circularly, the tool holder is located in each piece constituting the chain, a portion or all of the tool holders, having a fixed part fixed to the piece and a movable part rotatably supported relative to the fixed part, which alternatively change its posture between an exchange posture and a transport posture by rotating the movable part relative to the fixed part.

The machining center according to the fourth invention has the tool magazine of the first, the second or the third invention among the present invention.

### Effect of the Invention

With the first invention among the present inventions, at a portion or all of the tool holder, as the tools are held in a surface perpendicular to the rotating axis other than the time for exchanging the tool, the thickness of the tool magazine including the tool in the rotating axis direction can stay thin even in the case that a long tool is included. Therefore, there is no need to increase the size of the magazine cover or to store only the long tools at separate location, then both of a long tool and other tools can reasonably coexist in a same tool magazine.

With the second invention among the present inventions, even in the case that any heavy long tool is included in tools, by holding the long tool with the tool holder in the separate body portion, the center of gravity of the long tool is shifted toward the center of the disk as the long tool changes its posture that is perpendicular to the rotating axis of the magazine main body (parallel to the disk surface) by making the separate body portion stand up. Therefore, the inertia of the tool magazine with the tools does not increase and the misalignment of a center of gravity from a center of rotation become small, so that there is no extra load to a motor and a rotating shaft that rotates the magazine main body.

With the third invention among the present inventions, especially when the tool is held in horizontal direction, even any heavy long tool is included is tools, a moment that a piece receives become smaller as the moment arm become shorter since the long tool comes closer to the piece holding it by rotating the movable part so as that the tool holder takes the transport posture, and the chain or its driving motor does not get extra loads as a result.

With the fourth invention among the present invention, by having the above described tool magazine, there is no need to increase the size of the magazine cover or to store only the long tool at separate location, and the load applied to the tool magazine and the motor that rotates it become small, so that a motor and the driving mechanism can be small. Therefore, the size of the whole machining center can be small, while accommodating the long tools.

### BRIEF DESCRIPTION OF DRAWINGS

FIG. 1 is a perspective diagram of the first embodiment (disk shape/horizontal type) in the transport posture according to the present invention.

FIG. 2 is a perspective diagram of the first embodiment (disk shape/horizontal type) in the exchange posture according to the present invention.

FIG. 3(a) is an illustration of the transport posture of the first embodiment (disk shape/horizontal type).

FIG. 3(b) is an illustration of the exchange posture of the first embodiment (disk shape/horizontal type).

FIG. 4 is a perspective diagram of the in the transport posture according to the present invention.

FIG. 5(a) is an illustration of the transport posture of the second embodiment (chain shape).

FIG. 5(b) is an illustration of the exchange posture of the second embodiment (chain shape).

FIG. 6 is a perspective diagram of the third embodiment (disk shape/horizontal type) in the exchange posture according to the present invention.

FIG. 7(a) is a plane view of the third embodiment (disk shape/horizontal type).

FIG. 7(b) is an illustration of the transport posture of the third embodiment (disk shape/horizontal type).

FIG. 7(c) is an illustration of the exchange posture of the third embodiment (disk shape/horizontal type).

FIG. 8(a) is an illustration of the conventional tool magazine (when a magazine cover is enlarged).

FIG. 8(b) is an illustration of the conventional tool magazine (when a long tool is stored at another place).

### EMBODIMENT OF PRESENT INVENTION

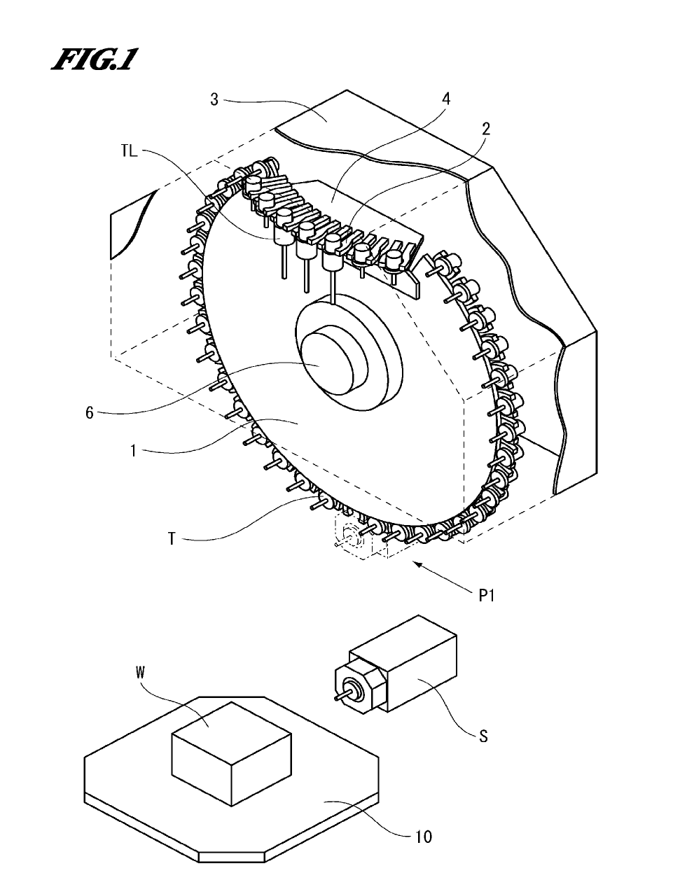

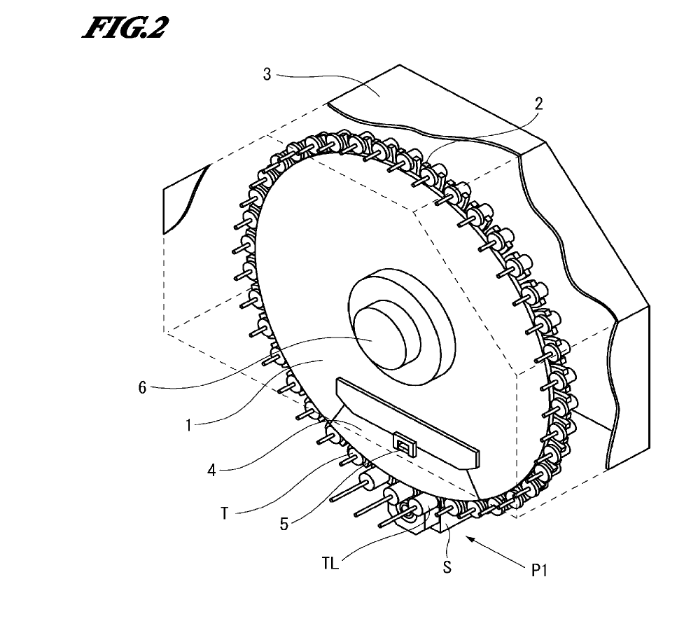

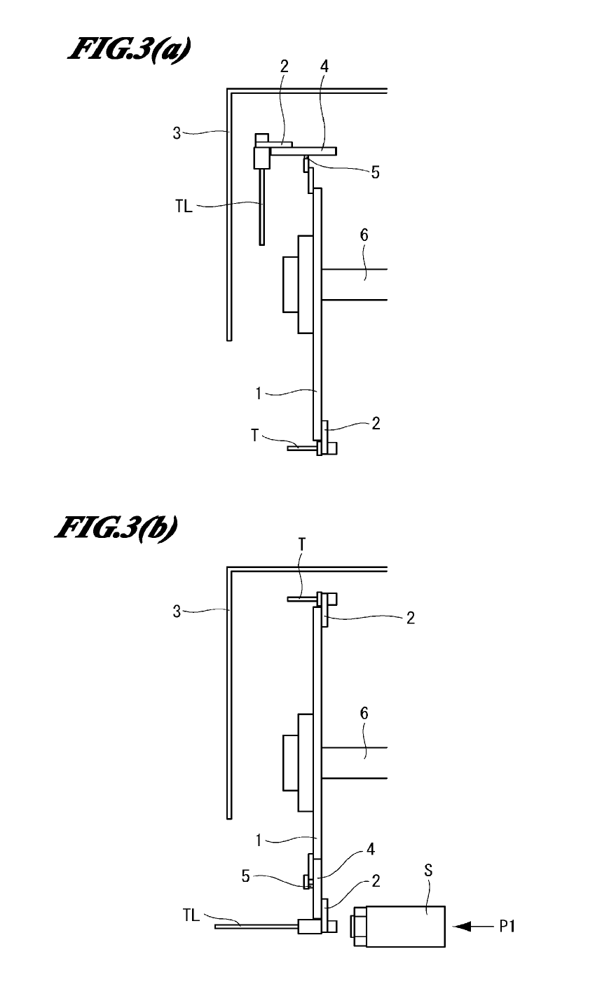

With reference to the drawings, the concrete construction of the tool magazine according to the present invention is described. The first embodiment of the tool magazine is, as shown in FIG. 1, FIG. 2, FIG. 3(a) and FIG. 3(b), the magazine main body 1 is disk shape, and is used for a horizontal type machining center that the main shaft S is installed in a horizontal direction. Magazine main body 1 is stood vertically, and the rotating axis 6 is installed in a horizontal direction at the disk center and is rotatable. Tool holders 2 are installed all around the penumbra of the magazine main body 1. Each tool holder 2 holds a tool T with a pair of gripper arms respectively, for example. There are 40 holders in this embodiment. And, a part of magazine main body 1 including consecutive seven (7) pieces of tool holders 2 is constructed as a separate body pan 4. The separate body part 4 is attached to the magazine main body 1 with a hinge 5, and it can stand up relative to the disk surface. It should be noted that the tool T is held in the direction that is parallel to the axial direction of the rotation shaft 6 when the separate body part 4 is placed along the disk surface (FIG. 2, FIG. 3(b)), which is referred to as exchange posture. On the other hand, the tool T is held in the direction that is perpendicular to the axial direction of the rotation shaft 6 when the separate body part 4 stand up to the disk surface (FIG. 1, FIG. 3(a)), which is referred to as transport posture. As for the magazine main body 1, about a top half is covered by a magazine cover 3. Additionally, the main shaft S and a table 10 are installed in the lower part of the magazine main body 1, and a work W that is a processing object is fixed on the table 10. The main shaft S is movable in both vertical and horizontal directions.

With the tool magazine constructed as described above, the toll holder in the separate body part 4 holds a long tool TL that is longer than ordinary tool T. Except for such location, the long tool TL interferes with the magazine cover 3, however, in the case of separate body part 4, the interference can be avoided by making the tool holder 2 take a transport posture and the separate body part 4 stand up as shown in FIG. 1 and FIG. 3(a) on a disk surface plane. Also, by making the separate body part 4 stand up, the long tool TL takes a posture that is perpendicular to the rotation shaft 6 (parallel to the disk surface), and the center of gravity of the long tool TL shifts to the center of the disk, which the inertia of the tool magazine including the tool T does not become large. Further more, the deviation of the center of gravity from the center of rotation become small, so there is no extra load to a motor and a rotating shaft that rotate the tool magazine.

Moreover, in the case that the long tool TL held by the separate body part 4 is used, the main shaft S moves to a tool exchange position P1 (a position of tool holder 2 right under the rotation axis 6) and the tool T is transferred to an empty tool holder 2. And the magazine main body 1 rotates to move the tool holder 2 with a necessary long tool TL to the tool exchange position P1. In doing so, the stood up separate body part 4 now becomes in parallel with the disk surface and the tool holder 2 is in the exchange posture, and the main shaft S receives long shot tool TL, as shown in FIG. 2 and FIG. 3(b). After that, in accordance with the instructions from a control unit (not shown in the drawings), the main shaft S processes the work W with the long tool TL attached on its tip, and a tool is exchanged again when the predetermined process is completed. In other words, the long tool TL is transferred to an empty tool holder 2 and the magazine main body 1 rotates. If next tool T is held in a location other than the separate body part 4, the separate body part 4 stands up again to make the tool holder 2 in the transport posture. It should be noted that, in order to operate the separate body part 4 to change its position between the exchange posture and the transport posture, the magazine main body 1 may be provided with (not shown in drawings) such as a servomotor or some kind of actuators, or a guide rail or the like is installed outside of the magazine main body 1 (not shown in the drawings) to abut with the separate body part 4 so that the tool holder 2 in the separate body part 4 changes to the exchange poster along with the guide rail as the separate body part 4 approaches to the tool exchange position P1 and returns to the transport posture along with the guide rail as the separate body part 4 leaves from there.

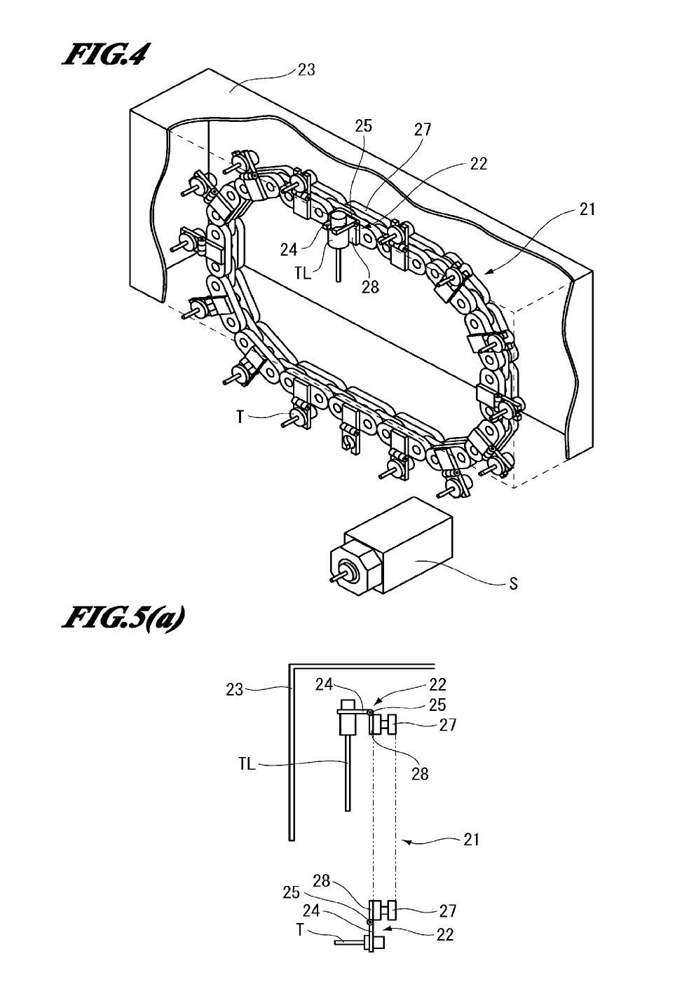

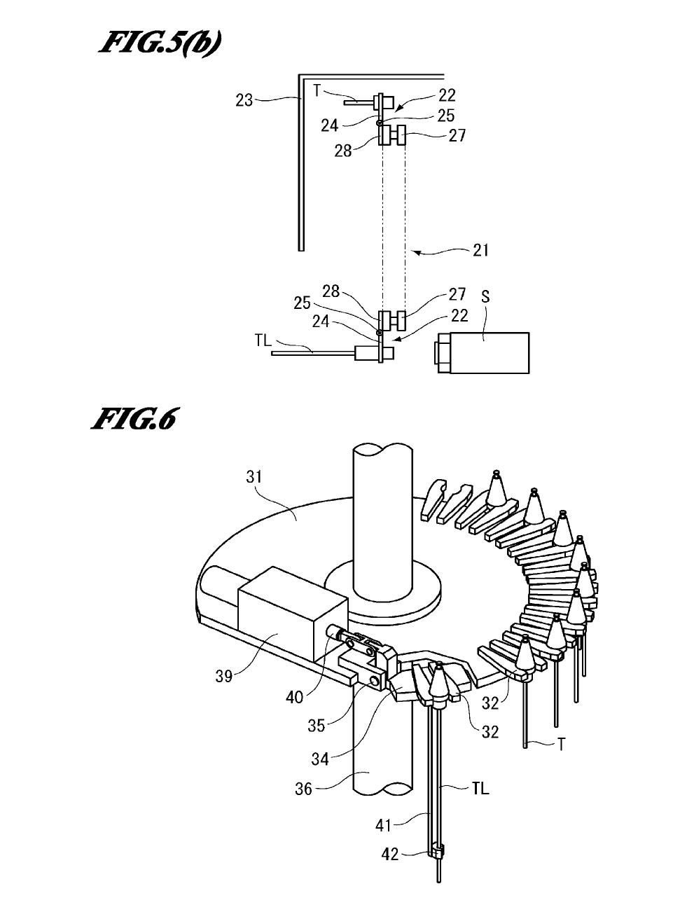

The second embodiment of the tool magazine according to the present invention is described now. In the second embodiment, the magazine main body 21 is in a form of chain. The magazine main body 21 is formed by plural pieces 27 circumferentially coupled each other shown in FIG. 4, FIG. 5(a) and FIG. 5(b), and for example, is revolvingly driven about an axis in parallel with the axial direction of the main shaft S (the driving mechanism is not shown in the drawings.) The tool holder 22 is installed in each piece 27, and the tool holder has a fixed part 28 fixed to the piece 27 and a movable part 24 that can stand up from the fixed part 28. The fixed part 28 is formed of a flat board, and the movable part 24 for example has a pair of gripping arms that wrap around and hold the tool T, and both of the fixed part 28 and the movable part 24 are coupled with a hinge 25. Same as the first embodiment, the exchange posture is formed by holding the tool T in the direction that is parallel to the axial direction of the magazine main body 21 when the movable part 24 and the fixed part 28 are in the same direction, and the transport posture is formed by holding the tool T in the direction that is perpendicular to the axial direction of the magazine main body 21 when the movable part 24 stands up relative to the fixed part 28.

With the tool magazine constructed as such, an interference with the magazine cover 23 can be avoided by making the movable part 24 stand up against the fixed part 28 to make the tool holder 22 in the transport posture, in the case that the long tool TL is held as shown in FIG. 4 and FIG. 5(a). Especially in the case of the horizontal type machining center with a main shaft S installed in a horizontal direction, even a heavy long tool TL is included with tools T, by making the tool holders 22 in the transport posture by making the movable part 24 stand up, the moment arm become shorter as the long tool TL becomes closer to the piece 27 that hold the it, and the chain or its driving motor (not shown in the drawings) does not get extra load as a result. And, when the long tool TL is used for processing, the tool holder 22 takes the exchange posture as the movable part 24 become parallel with the fixed part 28. It should be noted that the magazine main body 21 can be provided with a servomotor etc. (not shown in the drawings), or a guide rail etc. is installed outside of the magazine main body 21 (not shown in the drawings) to abut with the separate body part 4 in the same way as the first embodiment, in order to switch between the exchange posture and the transport posture.

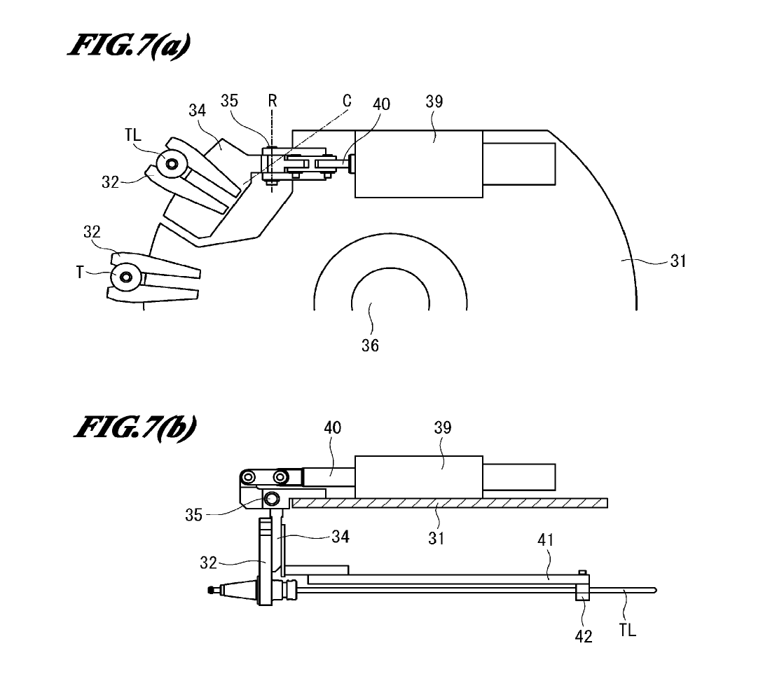

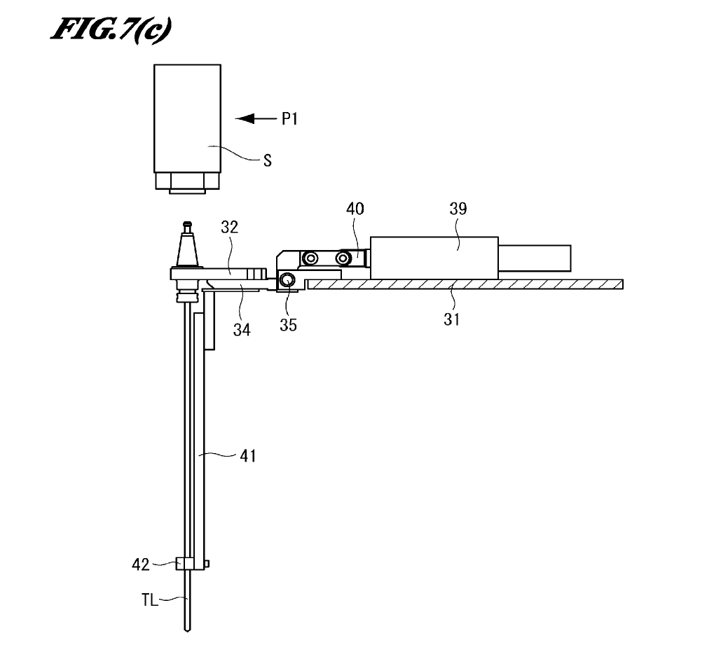

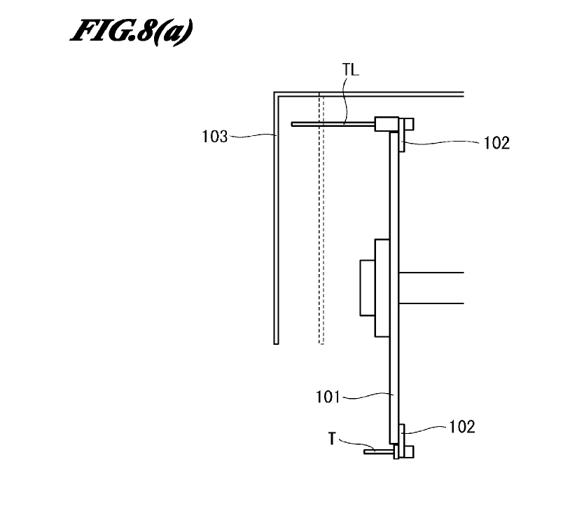

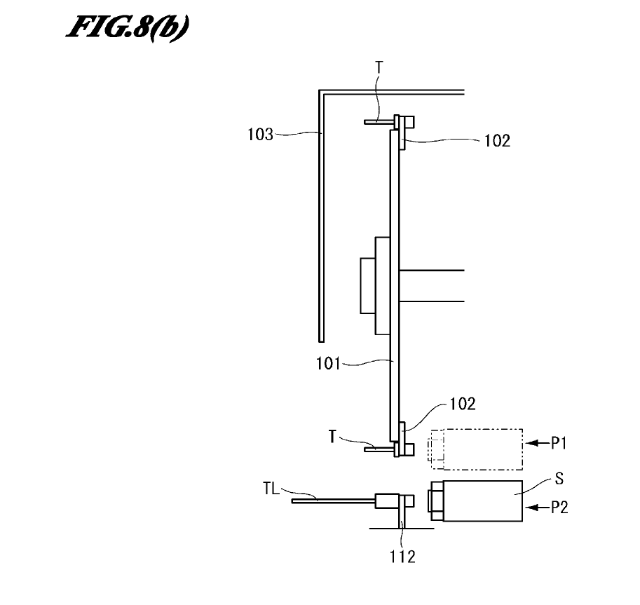

Next the tired embodiment of the tool magazine according to the present invention is described. In the case of the third embodiment, the magazine main body 31 is roughly in a disk shape and suitable to be used for a machining center of the form where main shaft S is installed in the vertical direction, as shown in FIG. 6, FIG. 7(a), FIG. 7(b) and FIG. 7(c). The magazine main body 31 is installed in horizontally, the rotating shaft 36 penetrates through the disk center in vertical direction in rotatably connected fashion. Tool holders 32 are installed in the penumbra of magazine main body 31. The tool holder 32 is for holding the tool T with a couple of gripping arms, there are 10 pieces of tool holders 32 are lined up in this embodiment. And, a part including one of the ends of the lined up tool holders 32 (this tool holder 32 holds a long tool TL that is longer than the ordinary tool T.) is constructed as a separate body part 34. The separate body part 34 is attached to the magazine main body 31 with a hinge 35, so that it can stand up downwardly relative to the disk surface. Here, the direction of the rotational axis (the line R in FIG. 7(a)) of hinge 35 is inclined with respect to the circumferential direction (the line C of FIG. 7(a)) of the magazine main body 31. Also, a supporting arm 41 is extended downwardly from the bottom side of the separate body part 34, and a brace 42 supporting a tip section of the long tool TL is installed in the tip of the support arm 41. An air cylinder 39 that is driven in a horizontal movement is installed on the top surface of the magazine main body 31, and a rod 40 in the air cylinder 39 is connected to the upper part of the hinge 35 of the separate body part 34, so that the exchange posture is taken when the rod 40 is retracted (The separate body part 34 become along the disk sides and the in long tool TL turns to the vertical direction, and, as shown in FIG. 7(c)) and the transport posture is obtained when the rod 40 is advanced (The separate body part 34 stands up for the disk sides and the in long tool TL turns to the horizontal direction, and, as shown in FIG. 7(b)). It should be noted that the main shaft S is installed at the upper side of the magazine main body 31 and freely movable both in a vertical and horizontal directions.

A procedure of the tool exchange is described in the above explained tool magazine construction where only the tool holder 32 in the separate body part 34 holds a long tool TL and other tool holders 32 hold ordinary tools T. In the case that the ordinary tool T attached to the main shaft S is to be replaced with the long tool TL, the main shaft S moves in a horizontal direction to the tool exchange position P1 for transferring the tool T to an empty tool holder 32 first, then it moves to vertical upwardly to remove the tool T. Sequentially, the magazine main body 31 rotates to move the separate body part 34 into the tool exchange position P1. Then, the air cylinder 39 is activated to make the separate body part 34 in the exchange posture (FIG. 7(c)). Lastly, the main shaft S moves vertical downwardly and attaches the long tool TL, then moves horizontally to remove it from the magazine main body 31. In the case that the long tool TL attached to the main shaft S is to be replaced with the ordinary tool T, the main shaft S moves in a horizontal direction to the tool exchange position P1 for transferring the long tool TL to an empty tool holder 32 within the separate body part 34 first, then it moves to vertical upwardly to remove the long tool TL. The air cylinder 39 is activated to make the separate body part 34 in the transport posture (FIG. 7(b)). Sequentially, the magazine main body 31 rotates to move the other tool holder 32 into the tool exchange position P1. Lastly, the main shaft S moves vertical downwardly and attaches the tool T, then moves horizontally to remove it from the magazine main body 31. It should be noted that the switching of the postures of the separate body part 34 by the air cylinder 39 always takes place when the separate body part 34 is at the tool exchange position P1 as mentioned above. Therefore, in the case that the housing is located underneath the magazine main body 31, it is sufficient for example to create clearance by forming a recess at in a passage range of long tool TL in order to avoid interference during the time when switching the postures at the tool exchange position P1. It is possible to hold a normal tool T at the tool holder 32 in the separate body part 34, then it can maintain the exchange posture all the time.

Even in the third embodiment, interference of the long tool TL is avoided with neighboring structures such as a magazine cover and the housing by taking the transport posture when the magazine main body 31 is rotated in the case that the long tool TL is held by the separate body part 34. By making the separate body part 34 stand up and take the transport posture, the long tool TL takes a posture that is perpendicular to the rotation shaft 36 (parallel to the disk surface) and the center of gravity of the long tool TL shift to the center of the disk, so that the inertia of the tool magazine including the tool T increases less and the deviation of the center of gravity from the center of rotation become small, then the motor (not shown in the drawings) rotating the tool magazine and the rotation shaft 36 get no extra load. Additionally, because the axis of rotation of the hinge 35 (the line R in FIG. 7(a)) coupling the magazine main body 31 and the separate body part 34 is inclined with respect to the circumferential direction (the line C in FIG. 7(a)) of the magazine main body 31, the long tool TL deflects from the center of the magazine main body 31 (rotation shaft 36) when the transport posture is taken, so there is no interference between the long tool LT and the rotation shaft 36, which makes it possible to hold a long tool TL that is almost as long as the diameter of the magazine main body 31. Furthermore, by having the brace 42, the long tool TL oriented to the horizontal direction is kept stable during the time the magazine main body 31 is in rotation.

Moreover, the machining center according to the present invention is constructed with control unit that controls the magazine main body and the main shaft and a control panel inputting the processing data for the work etc. and others besides the tool magazine described above, however. It is similar to the conventional machining center other than the tool magazine. It should be noted that the tool magazine according to the present invention can be used by either the machining center of vertical type or the machining center of horizontal type, and it is possible to use the tool magazine of the first and the second embodiments with the vertical type machining center by installing the magazine main body 1, 21 horizontally, and to use the tool magazine of the third embodiment with the horizontal type machining center by installing the magazine main body 31 vertically. It is also possible to use with the machining center of the type that tools are exchanged between the tool magazine and the main shaft by an ATC arm.

The present invention is not limited to the embodiments disclosed above. For example, in the case of the disk-shaped tool magazine, one tool holder may be installed in one separate body part, and two or more tool holders can be installed also, and plural of separate body parts with a single tool holder or plural of separate body parts with two or more tool holders can be installed. Additionally, in the case of the chain-shaped tool magazine, only some of the pieces may have a tool holder changeable between the exchange posture and the transport posture and other pieces may have a tool holder fixed to the exchange posture also. Furthermore, the fixed part in the tool holder can be attached to a piece as a separate member, or can be formed with the piece in one body also. Moreover, it is possible to detect the breakage or loss of the tool by installing a detecting device such as a contact type sensor on the orbit of the tools changing its transport posture and exchange posture or a non-contact type sensor.

### INDUSTRIAL APPLICABILITY

The machining center with a tool magazine that can hold a long tool together with ordinary tools and still has a small form factor can be provided.

### EXPLANATION OF SYMBOLS

1, 21, 31: magazine main body

2, 22, 32: tool holder(s)

4, 34: separate body part

24: Movable part

27: piece(s)

28: fixed part

S: main shaft

T: tool(s)

1. A tool magazine for holding a tool to be attached to a main shaft of a machining center comprising:
a rotatable magazine main body; and
plural of tool holders installed on the magazine main body;
wherein each of the tool holders moves to a tool exchange position sequentially, a part or all of the tool holders is capable of changing its posture between an exchange posture that holds the tool in parallel to a rotation shaft of the magazine main body and a transport posture that holds the tool along with a plane perpendicular to the rotation shaft of the magazine main body,
wherein the tool holder capable of changing postures takes the exchange posture when it is located in the tool exchange position and takes the transport posture when it leave the exchange position.”

2. The tool magazine according to claim 1, wherein the magazine main body has almost disk shape rotatable about a disk center axis, the tool holder is installed in the penumbra of the magazine main body, a portion including the penumbra of the magazine main body is formed as a separate body part, the separate body part is capable of standing up relative to a disk surface, and the tool holder installed on in the separate body part becomes the exchange posture by orientating the separate body part along with the disk surface and becomes the transport posture by making the separate body part stand up relative to the disk surface.

3. The tool magazine according to claim 1, wherein the magazine main body has an annular chain and driven circularly, the tool holder is installed on a piece of the chain that forms the magazine main body, a part or all of the tool holders has a fixed part fixed to the piece and a movable part that is fixed to the piece and movably hold the tool that can change between the exchange posture and the transport posture by rotating the movable part relative to the fixed part.

4. A machining center including any one of the tool magazine according to the claim 1.
